(19) United States
(12) Patent Application Publication
(10) Pub. No.: US 2003/0150304 A1
(43) Pub. Date: Aug. 14, 2003

(54) Collet assembly for holding and ejecting a workpiece

(76) Inventor: Brian Paul Morgan, Minneapolis, MN (US)

Correspondence Address: Michael A. Mochinski, Attorney at Law, 3300 Bass Lake Road, Suite 514, Brooklyn Center, MN, 55429, US

(21) Appl. No.: 10/075,165

(22) Filed: Feb. 13, 2002

(51) Int. Cl. B23B 31/00; B23B 25/00

(52) U.S. Cl. 82/155; 82/162

(57) ABSTRACT

An improved collet assembly made adaptable for use in a computer numerical controlled (CNC) machine as well as in a non-CNC type of machine having one or more sub-spindles adaptably configured to accept and receive the collet assembly. The collet assembly generally comprising a collet body geometrically configured to accept and house a plunger assembly comprising a plunger cylinder integrally attached to a plunger rod having one end threadably attached to an ejector tip and a second end slidably engaged to a plunger retainer and fitted with biasing means, all of which serving as means to hold a workpiece during machining thereof and eject the workpiece from the collet body as biasing means advances forward within the collet body to a fully extended state.

### FIELD OF THE INVENTION

The present invention relates in general to an improved collet assembly for retention of a workpiece during machining operations and ejector for sustained and reliable automated removal of a machined part and the like. More particularly, the present invention relates to an improved collet assembly made adaptable for use in a sub-spindle often utilized in and made part of a computerized numerical controlled (CNC) turning and milling machine.

### BACKGROUND OF THE INVENTION

Many of today's machine shops utilize computerized numerical controlled (CNC) machines to automate the process of machining small, delicate parts for specialty industries, such as for the medical industry. A typical CNC machine, specifically of the lathe type having more than one sub-spindle for multi-machining of parts, comprises a headstock spindle that is adaptably equipped with a headstock collet assembly capable of allowing throughput and securing raw bar stock at the working area, a cutting tool of some type to shape and form the workpiece, a sub-spindle adaptably equipped with a workpiece collet to hold the workpiece in a stationary position, means for automated removal of the machined part or component, whether it be by fluid and/or mechanical means, and a computer controller to coordinate the above operating components for accurate and precise machining of the specialty part or component. In describing a typical machining operation, specifically involving a lathe, raw bar stock is generally advanced into a headstock spindle either by mechanical or pressure means and operably clamped in place using a headstock collet, which is movable between an open and closed position. While in a closed position about the raw bar stock, the cutting tool selectively engages the raw bar stock to shape and form the workpiece into the desired geometric configuration. Typical machining of the workpiece may include drilling and cutting operations, deburring, broaching, tapping, or other similar types of tooling methodologies. Thereafter, the workpiece is subjected to further machining in which the headstock collet is selectively opened to allow advancement of the workpiece into the collet contained within the sub-spindle or further positioned into the working area, where the workpiece is removed from the raw bar stock through cutting means and collected in a finished part receptacle. In instances where the workpiece is further machined, such as in the case to machine that portion of the workpiece left unfinished during the initial machining operation, the sub-spindle operably advances toward the partially finished workpiece and selectively grabs a portion of the workpiece to permit further machining thereof. Upon achieving the desired machined workpiece, the workpiece is then effectively removed from the sub-spindle by opening the collet generally through mechanical or hydraulic means and allowing either a mechanical ejector of some sort to engage and advance the finished workpiece from the collet or a fluidized type of ejector having the capability of introducing high pressure air or a liquid into the collet to effectively blast or discharge the finished workpiece therefrom. Some of the prior art devices teaching use of ejectors comprising mechanical or fluid means or a combination of both include U.S. Pat. No. 4,106,376 issued to Freer and U.S. Pat. No. 5,077,876 issued to McConkey. Freer teaches the use of an ejector rod to engage the workpiece and air to aid in the discharge of the finished workpiece from the sub-spindle assembly, in addition to removing chips and spent coolant from the collet and other working subassemblies. Similarly, McConkey teaches the use of high pressure liquid emanating from an inner shaft to effectively discharge the finished workpiece from the sub-spindle and collet assemblies. In typical instances where mechanical means for part ejection is employed, the ejector rod may be designed specifically for a certain sub-spindle configuration, such as in the case of CNC machines manufactured by CITIZEN. In these particular machines, the ejector rod may be of a substantial length, typically the length of the CNC machine, and will after some time, particularly after prolonged cyclic use, will become bent or disfigured to the extent of unreliable part ejection, necessitating replacement or adjustment. In typical instances of mechanical failure, it is often necessary to remove, repair, replace, and re-configure the entire sub-spindle and ejector rod assemblies to achieve desired working tolerances of the CNC machine. In similar regards, to accommodate machining of parts of varying size and shape, the ejector rod, sub-spindle, and collet may require substantial adjustment or entire replacement, perhaps to the level associated with mechanical failure.

Accordingly, there remains a need for a collet assembly capable of being easily fitted into existing sub-spindles of varying size to accommodate the machining of specialty parts and the like without undue downtime often associated with prior art devices.

### BRIEF SUMMARY OF THE INVENTION

In order to overcome the numerous drawbacks apparent in the prior art, an improved collet assembly has been devised for use in computerized numerical controlled (CNC) machines having turning and milling capabilities.

It is thus an object of the present invention to provide a low cost, non-complicated collet assembly which may be reliably used with numerous types of sub-spindles often utilized and incorporated in CNC machines.

It is another object of the present invention to provide such a collet assembly which affords versatility in terms of functioning on a variety of machines often found and used in a typical machining environment, including CNC and non-CNC type of machines having single and multiple sub-spindles.

It is another object of the present invention to provide such a collet assembly which possesses the capacity of being completely removed from the CNC machine without resorting to complete teardown and removal of other operating subassemblies, including sub-spindles and mechanical/fluidized part ejectors.

It is another object of the present invention to provide such a collet assembly which comprises means for ready removal from the CNC machine to minimize downtime often associated with prior art devices utilizing mechanical means for removing and discharging the finished workpiece from the sub-spindle and collet assemblies.

It is another object of the present invention to provide such a collet assembly which comprises means to accommodate the machining of workpieces of varying size, shape and form without having to remove the entire sub-spindle and/or part ejector assemblies.

It is yet another object of the present invention to provide such a collet assembly which accomplishes the foregoing and other objects and advantages and which is economical, durable, and fully effective in performing its intended functions without undue downtime.

In accordance with the present invention, an improved collet assembly has been devised for use in a computer numerical controlled (CNC) machine having one or more sub-spindles being geometrically configured to accept and receive a correspondingly configured collet assembly, the collet assembly comprising in combination a collet body having a tapered nose section for engaging a portion of a workpiece, a cylindrical barrel to house a plunger assembly and an upwardly flared section to effectively serve as a stop within the sub-spindle, the plunger assembly generally comprising a plunger rod integrally attached to a plunger cylinder near a first end having internal threads thereat and second end thereof slidably engaged to a plunger retainer adaptably configured to fit within and engage an end of the cylindrical barrel; an ejector tip threadably attached to the first end of the plunger rod, the ejector tip being configured to extend through and beyond the tapered nose section a predetermined distance to make initial contact with the workpiece; and biasing means for resilient, axial movement of the plunger assembly through and about the collet body, whereby the ejector tip is permitted to retract and compress biasing means as the workpiece substantially comes into contact therewith and eject the workpiece upon full extension of biasing means.

Other objects, features, and advantages of the present invention will become apparent in the following detailed description of the preferred embodiments thereof when read in conjunction with the accompanying drawings in which like reference numerals depict the same parts in the various views.

### BRIEF DESCRIPTION OF THE SEVERAL VIEWS OF THE DRAWINGS

A preferred embodiment of the present invention will now be described by way of example with reference to the accompanying drawings, in which:

FIG. 1 is a front perspective view of the preferred embodiment of the present invention;

FIG. 2 is a side elevational cross section view of the preferred embodiment of the present invention illustrating a plunger assembly configured within a collet body;

FIG. 3 is a front elevational view of the preferred embodiment of the present invention illustrating a collet body comprising a tapered nose section and collet segments in a substantially open position;

FIG. 4 is a back elevational view of the preferred embodiment of the present invention illustrating a collet body comprising a tapered nose section and collet segments in a substantially open position;

FIG. 5 is a front elevational view of the preferred embodiment of the present invention illustrating a disassembled plunger assembly;

FIG. 6 is a side elevational view of the preferred embodiment of the present invention illustrating a collet body configured with a plunger assembly;

FIG. 7 is a side elevational view of the preferred embodiment of the present invention taken on line 7-7 of FIG. 6 illustrating a collet body configured with a plunger assembly in an expanded, static state;

FIG. 8 is a back elevational view of the preferred embodiment of the present invention illustrating components comprising a plunger cylinder;

FIG. 9 is a back elevational view of the preferred embodiment of the present invention illustrating components comprising a plunger retainer;

FIG. 10 is a side elevational view of an alternative embodiment of the present invention illustrating a plunger retainer adaptably configured with an extended section; and

FIG. 11 is a back elevational view of an alternative embodiment of the present invention taken on line 11-11 of FIG. 10 illustrating a plunger retainer adaptably configured with an extended section.

### DETAILED DESCRIPTION OF THE PREFERRED EMBODIMENT

While this invention is susceptible of being embodied in many different forms, the preferred embodiment of the invention is illustrated in the accompanying drawings and described in detail hereinafter with the understanding that the present disclosure is to be considered to exemplify the principles of the present invention and is not intended to limit the invention to the embodiment illustrated. The present invention has particular utility as a device for use in a computer numerical controlled (CNC) machine as well as in a non-CNC type of machine having single and multiple sub-spindles.

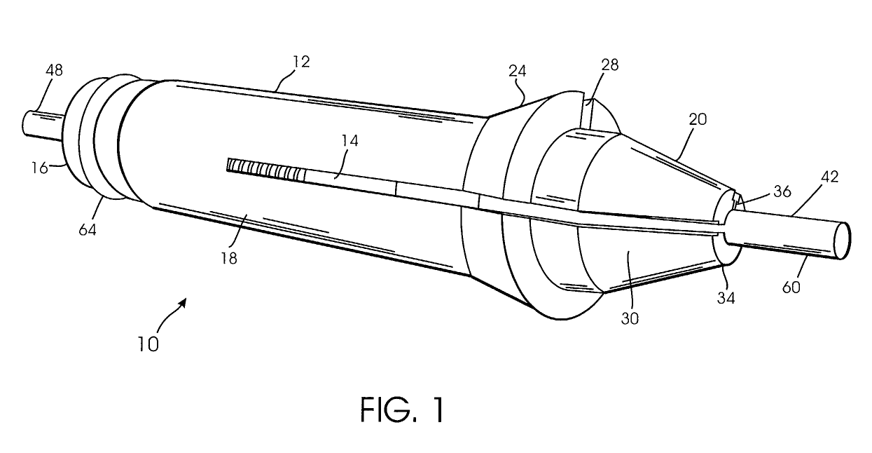

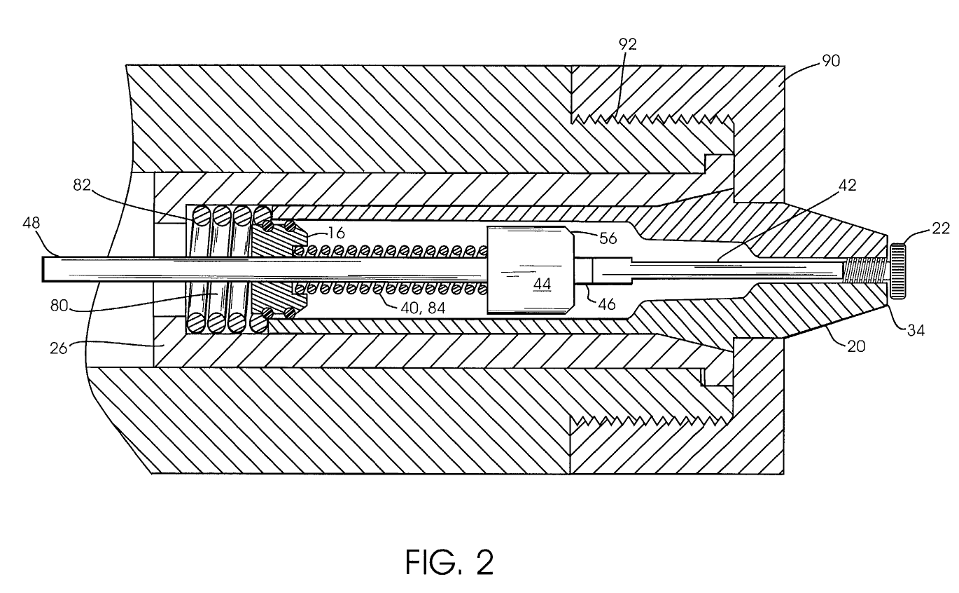

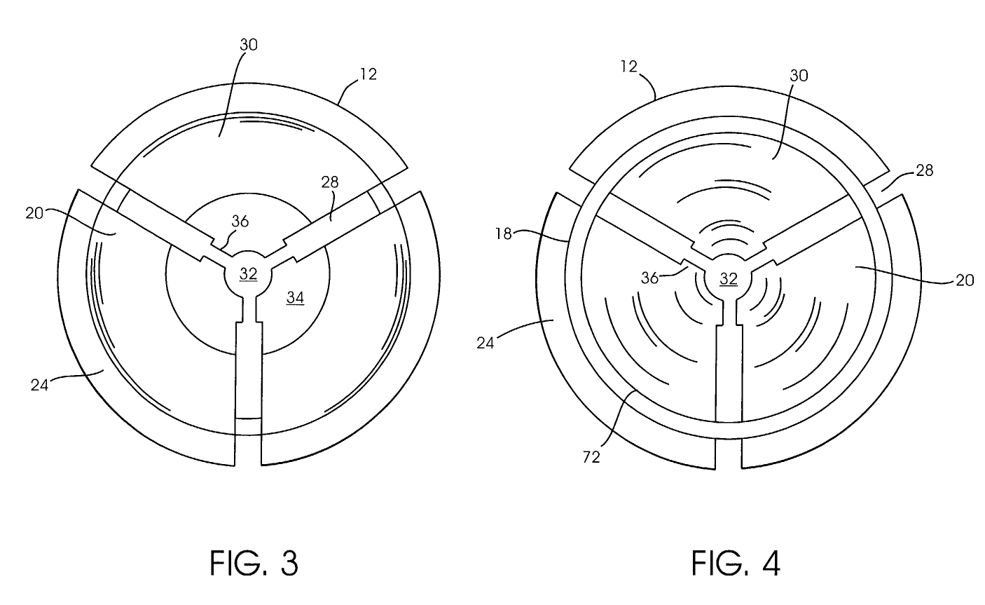

Referring to FIG. 1, there is shown generally at 10 an improved collet assembly comprising a collet body 12, a plunger assembly 14, and plunger retainer 16. By way of example, but not limited herein, a computer numerical controlled (CNC) machine of the type manufactured by CITIZEN, of Allendale, N.J., is described herein for purposes of illustrating the manner in which the present invention cooperates with such machine to achieve the desired overall objectives. In the preferred embodiment, the collet body comprises a cylindrical barrel 18 substantially configured to house the plunger assembly 14, a tapered nose section 20 for engaging a portion of the workpiece 22 and an upwardly flared section 24 existing between the cylindrical barrel 18 and tapered nose section 20. The upwardly flared section, as seen in FIG. 2, primarily serves as a stop to prohibit further axial movement of the collet body 12 into the sub-spindle assembly as the tapered nose section engages the workpiece and is generally geometrically configured, along with the cylindrical barrel 18, to conform to the geometric configuration of a chuck sleeve 26 generally made part of and incorporated in a CNC machine sub-spindle of the type commonly known in the art and presented herein. The tapered nose section 20 further comprises at least three longitudinal slots 28 which define a corresponding number of collet segments 30 and an aperture 32 at an outermost end 34 for receiving a portion of the workpiece 22, as best shown in FIGS. 3 and 4. Preferably, the longitudinal slots extend from the aperture 32 of the tapered nose section 20 to approximately one-third the distance from an end of the cylindrical barrel 18, where the plunger retainer 16 fittingly engages therein. As illustrated in FIG. 1, each of the longitudinal slots 28 comprises an axially extending protrusion 36, each of which extend longitudinally about the collet body 12, particularly starting from the aperture 32 of the tapered nose section to approximately the location of the upwardly flared section 24 of the collet body 12. This configuration serves to limit the extent to which the collet segments 30 radially move inward to grip the workpiece 22 while affording ample area for intrusion of lubricating oil into the cylindrical barrel 18. Only through this configuration is the plunger assembly 14 adequately lubricated to assure consistent cyclic action thereof for reliable part ejection.

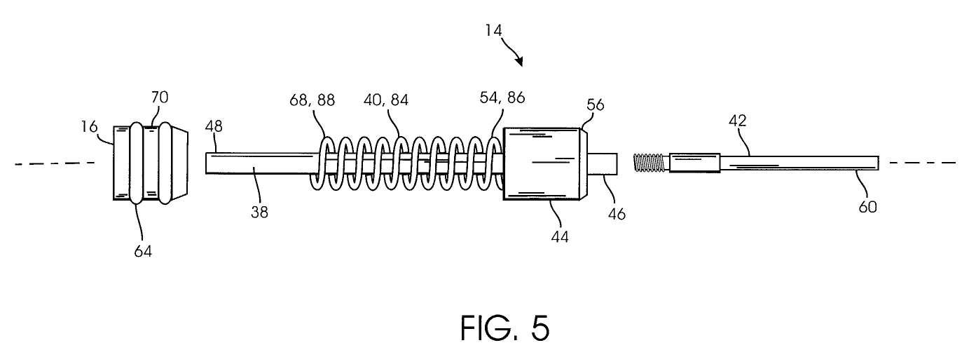

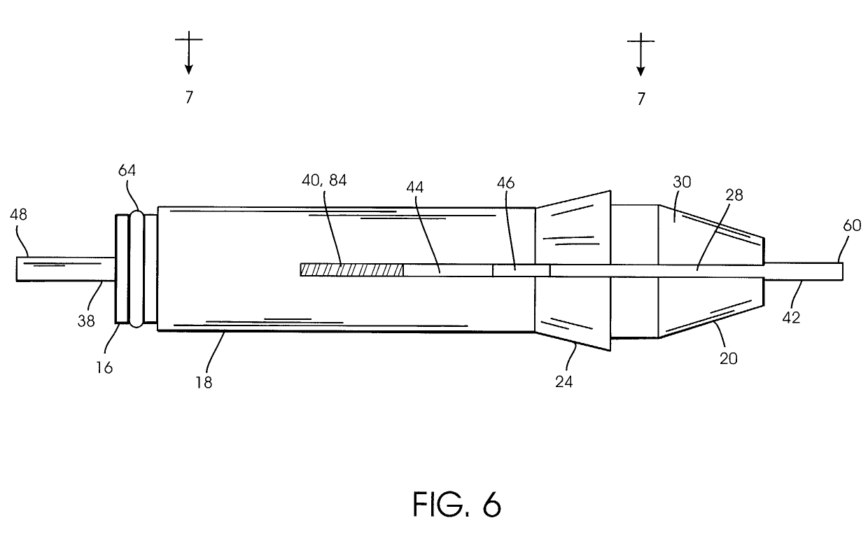

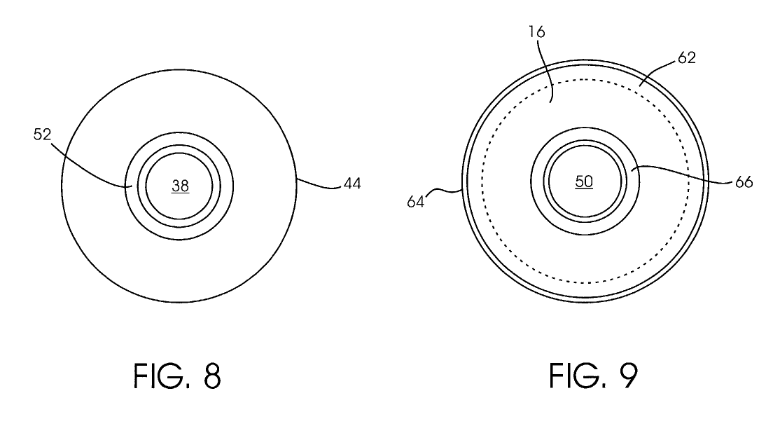

As depicted in FIG. 5, the plunger assembly 14 preferably comprises a plunger rod 38, biasing means 40, an ejector tip 42, and a plunger cylinder 44, all of which being coaxially arranged and adaptably configured to fit within the cylindrical barrel 18 and tapered nose section 20 of the collet body 12. The plunger rod generally comprises an elongate cylindrical configuration and is integrally connected to the plunger cylinder 44 located near a first end 46 of the plunger rod having an internal threaded portion thereat, while a second end 48 is configured to protrude through an axially extending aperture 50 made part of the plunger retainer 16 and extend a predetermined distance therefrom. As shown in FIGS. 6, 7 and 8, the plunger cylinder 44 comprises a concentric recess 52 adaptably configured to receive a proximal end 54 of biasing means 40 and an outermost concentric edge 56 being substantially chamfered to correspond to the geometric configuration of a plunger stop 58 located near the upwardly flared section 24, within the cylindrical barrel 18. The presence of the plunger stop effectively serves to limit the extent of forward travel of the plunger assembly 14 within the cylindrical barrel 18 during cyclic operation and most notably mates with the outermost concentric edge 56 during full extension of biasing means 40. Threadably engaged to the first end 46 of the plunger rod 38 is the ejector tip 42, which comprises a non-threaded end 60 extending a predetermined distance from the aperture 32 defined and formed by the collet segments 30, being most apparent when collet segments 30 are in a substantial closed position. In its static state, the ejector tip 42 is fully extended within the collet body 12 until which time it makes contact with the workpiece 22, most notably when the workpiece is picked off from a headstock spindle generally of the type incorporated in the CNC machine, and continues to retract until a substantial portion of the workpiece is retrieved and fitted within the collet segments 30; it is only after this time that biasing means 40 is positioned in a fully compressed state, as shown in FIG. 2. In the preferred embodiment, the ejector tip 42 is fabricated from stainless steel insofar to minimize wear and tolerate the high cyclic action of the plunger assembly as the ejector tip comes into contact and engages the workpiece 22.

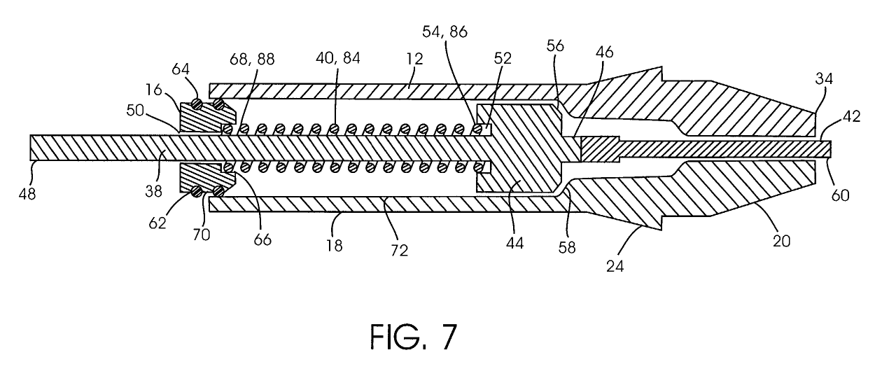

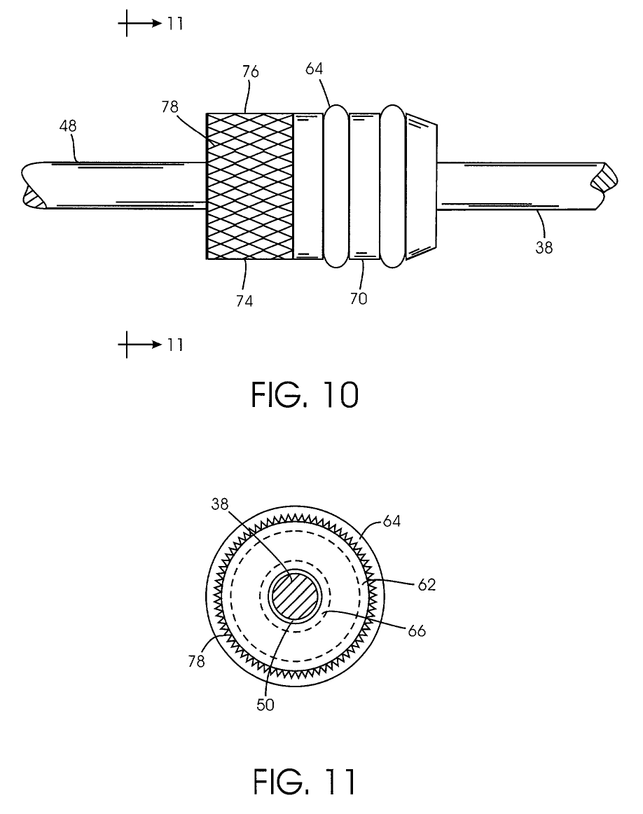

Referring now to FIGS. 7 and 9, the plunger retainer 16 comprises at least a pair of concentric grooves 62 geometrically configured to accept and receive a corresponding number of elastomeric o-rings 64 and a concentric recess 66 to accept and receive a distal end 68 of biasing means 40. Preferably, the concentric grooves 62 are spaced equally apart and configured parallel to one another, each of which having a predetermined depth to permit one-half of the thickness of the o-ring 64 to extend beyond an exterior surface 70 of the plunger retainer 16. This configuration allows ample opportunity for the o-ring to mate with and tighteningly engage an inner wall 72 of the cylindrical barrel 18 and lock the plunger retainer to the collet body 12 primarily through frictional means, as best shown in FIG. 7. In its fitted state, the plunger retainer is inserted into the cylindrical barrel 18 until one or two of the o-rings 64 substantially extend and exist therewithin, while the plunger rod 38 is adaptably fitted through the axially extending aperture 50, which preferably comprises a diameter slightly less than the plunger rod's diameter to permit sliding action therethrough. In some instances, it may be preferable to slidably position the plunger retainer 16 more so into the cylindrical barrel to afford the user adequate means to adjust and control the compressive loading of biasing means 40, being most particularly needed to control proper ejection of the workpiece 22 from the aperture 32 defined and formed by the collet segments 30. In an alternative embodiment, the plunger retainer may comprise means for simple removal of the plunger retainer from the cylindrical barrel for purposes of replacing or exchanging of the ejector tip 42, being more specifically needed when one or more o-rings engage the inner wall 72 of the cylindrical barrel to control the extent of resiliency of biasing means. The preferred removal means simply comprises an extended section 74 having an exterior portion 76 integrally configured with a knurled pattern 78. As depicted in FIGS. 10 and 11, the extended section is preferably an extension of the plunger retainer 16 in terms of shape and form and is further geometrically configured to fit more so within an inner cylindrical space 80 formed by a square spring 82 of the type commonly used in and made part of the sub-spindle assembly.

As shown in FIG. 5, biasing means 40 preferably comprises a spring 84 having a length of approximately one inch and first and second ends 86, 88, each end having diameters substantially equivalent to the concentric recesses 52, 66 of the plunger cylinder 44 and plunger retainer 16, respectively. The recesses serve to assist in mitigating unwanted rotational motion and ensuring proper axial alignment of biasing means 40 or spring 84 as it compresses and expands about the plunger rod 38 and slidably travels with the plunger assembly 14 about the cylindrical barrel 18 during cyclic operation. As illustrated in FIG. 7, the spring is positioned onto the plunger rod 38 until the first end 54 fits into and adaptably engages the recess of the plunger cylinder, while the second end 88 of the spring, in similar regards, fits into and adaptably engages the recess of the plunger retainer after slidably positioning the plunger rod through the axially extending aperture 50 and inserting the plunger retainer 16 into the cylindrical barrel 18 of the collet body 12, as hereinbefore described. In the preferred embodiment, the spring should possess sufficient resiliency so as to allow adequate ejection of the finished part from the collet as the spring 84 cycles from a compressed state to an expanded state. However, the spring should not be sufficiently stiff insofar to act against and allow axial movement of the plunger retainer 16 about the cylindrical barrel, since the plunger retainer is primarily held in place through frictional means established by the presence of the elastomeric o-rings 64 engaging a portion of the cylindrical barrel 18, particularly the inner wall 72 thereof.

By way of illustrating the application of the present invention and its use in a CNC machine of the type manufactured by CITIZEN, the existing collet and ejector assemblies are removed from the sub-spindle and replaced with the present invention, with the plunger assembly 14 being adaptably configured and positioned within the collet body 12, as illustrated in FIG. 7. The collet assembly is then positioned within the chuck sleeve 26, which is typically removable from the sub-spindle assembly. As depicted in FIG. 2, a cap nut 90, which is threadably attached to a threaded portion 92 of the sub-spindle, holds the collet assembly and chuck sleeve in place during machining operations. During a typical machining operation, the sub-spindle, by way of either mechanical or hydraulic means, will advance toward and pick off the partially-finished workpiece from the headstock spindle (not shown herein). At this stage, the collet segments 30 are configured in a closing relationship about the workpiece 22, with the plunger assembly 14 being positioned in a retracted state, the ejector tip 42 being positioned in abutting relationship to the workpiece, and biasing means 40 or spring 84 being configured in a compressed state, as shown in FIG. 2. Thereafter, a cutting tool operably proceeds to shape and form the workpiece into the desired geometric configuration. After completing the cutting operation, a computer controller actuates the sub-spindle to open, which correspondingly causes the collet segments 30 to move radially outward, biasing means to advance axially through and about the collet body 12, and the plunger assembly fitted with the ejector tip 42 to advance forward and toward the aperture 32 of the tapered nose section 20. This sequence of operable events finally causes the finished part to be ejected from the collet body 12 and received in a part receptacle of some sort. Should it be desirable or necessary to change out the ejector tip 42 for repair or replacement, the collet body is simply removed the sub-spindle assembly, with the plunger retainer 16 being twistably and slidably removed from the cylindrical barrel 18. As previously indicated, the plunger retainer may comprise an extended section 74 integrally configured with a knurled pattern 78 to simplify hand removal thereof from the collet body. Ejector tip replacement is simply performed by threadably disengaging and re-engaging the ejector tip 42 from and to the threaded end 46 of the plunger rod 38, respectively.

It can be seen from the foregoing that there is provided in accordance with this invention a simple and easily operated device, which is particularly suitable for use in a CNC machine as well as in non-CNC type of machines commonly known in the art and utilized in a typical machining environment. The collet assembly 10 is completely functional in terms of accommodating the machining of parts of varying size and shape, with little or no significant downtime during change out thereof.

It is obvious that the components comprising the collet assembly may be fabricated from a variety of materials, providing such selection or use of materials possess the capacity of withstanding moderate forces and stresses that may be encountered during typical machining operations. It is most desirable, and therefore preferred, to construct the collet body 12 from high grade carbon steel to ensure long-term wear, while components comprising the plunger assembly 14 are constructed from stainless steel to ensure sustained reliability during cyclic operation.

While there has been shown and described a particular embodiment of the invention, it will be obvious to those skilled in the art that various changes and alterations can be made therein without departing from the invention and, therefore, it is aimed in the appended claims to cover all such changes and alterations as fall within the true spirit and scope of the invention.

What is claimed is:

1. An improved collet assembly made adaptable for use in a computer numerical controlled machine having a sub-spindle being geometrically configured to accept and receive a correspondingly configured collet assembly, said collet assembly comprising, in combination:
a collet body having a tapered nose section for engaging a portion of a workpiece and a cylindrical barrel to house a plunger assembly and substantially retain a plunger retainer therein;
an ejector tip coaxially aligned with and threadably engaged to said plunger assembly, said ejector tip having a non-threaded end adaptably configured to extend through and beyond said tapered nose section a predetermined distance; and
biasing means for resilient, axial movement of said plunger assembly about and through said collet body, whereby said ejector tip retracts as the workpiece substantially comes into contact therewith and extends beyond said tapered nose section upon full extension of biasing means.

2. An improved collet assembly as set forth in claim 1, wherein said plunger retainer comprises at least a pair of concentric grooves for receiving a corresponding number of elastomeric o-rings, each having a thickness to permit one-half thereof to extend beyond an exterior surface of said plunger retainer to mate with and tighteningly engage an inner wall made part of said cylindrical barrel.

3. An improved collet assembly as set forth in claim 2, wherein said concentric grooves are parallel to and equidistant from one another.

4. An improved collet assembly as set forth in claim 1, wherein said biasing means comprises a spring having a length approximating one inch and adaptably fitted and configured to accept and permit passage of said plunger assembly.

5. An improved collet assembly as set forth in claim 4, wherein said spring comprises sufficient resiliency so as to allow adequate ejection of the workpiece from said collect body as said spring cycles from a compressed state to an expanded state.

6. An improved collet assembly as set forth in claim 4, wherein said spring comprises sufficient resiliency so as not cause axial movement of said plunger retainer about said cylindrical barrel as said spring cycles from a compressed state to an expanded state.

7. An improved collet assembly as set forth in claim 1, wherein said tapered nose section comprises at least three longitudinal slots defining a corresponding number of collet segments and an aperture at an outermost end thereof for receiving and engaging a portion of the workpiece.

8. An improved collet assembly as set forth in claim 7, wherein each of said longitudinal slots comprises an axially extending protrusion extending longitudinally thereabout a predetermined distance, said axially extending protrusions extending inwardly a predetermined distance to effectively limit the extent to which said collet segments radially move inward to grip the workpiece while affording ample area for intrusion of lubricating oils into said cylindrical barrel.

9. An improved collet assembly as set forth in claim 1, wherein said plunger assembly comprises a plunger rod integrally attached to a plunger cylinder near a first end having internal threads thereat and second end thereof adaptably configured to slidably engage through an axially extending aperture made part of said plunger retainer.

10. An improved collet assembly as set forth in claim 9, wherein said plunger cylinder comprises an outermost concentric edge substantially chambered to correspond to the geometric configuration of a plunger stop located near an upwardly flared section of said cylindrical barrel, said plunger stop serving to limit the extent of axial, forward travel of said plunger assembly within said cylindrical barrel, most notably mating with said outermost concentric edge during full extension of biasing means.

11. An improved collet assembly as set forth in claim 9, wherein said plunger cylinder and plunger retainer each comprise a concentric recess for receiving proximal and distal ends of biasing means, respectively, said recesses serving to steadily hold biasing means about said plunger rod insofar to mitigate unwanted rotational motion and ensure proper axial alignment thereof during cyclic operation.

12. An improved collet assembly as set forth in claim 1, wherein said plunger retainer further comprises means for removing said plunger retainer from said cylindrical barrel for convenient replacement or exchange of said ejector tip.

13. An improved collet assembly as set forth in claim 12, wherein said removing means comprises an extended section having an exterior portion integrally configured with a knurled pattern, said extended section substantially being an extension of said plunger retainer in terms of shape and form and further geometrically configured to fit within an inner cylindrical space formed by a square spring generally made part of the sub-spindle.

14. An improved collet assembly made adaptable for use in a computer numerical controlled machine having a sub-spindle being geometrically configured to accept and receive a correspondingly configured collet assembly, said collet assembly comprising, in combination:
a collet body having a tapered nose section for engaging a portion of a workpiece, a cylindrical barrel to house a plunger assembly and an upwardly flared section to effectively serve as a stop within the sub-spindle, said plunger assembly comprising a plunger rod integrally attached to a plunger cylinder near a first end having internal threads thereat and second end thereof adaptably configured to slidably engage through an axially extending aperture made part of a plunger retainer adaptably configured to fit into said cylindrical barrel;
an ejector tip having a threaded end threadably engaged to said first end of said plunger rod and a non-threaded end extending through and beyond said tapered nose section a predetermined distance; and
a spring having first and second ends, each being geometrically configured to fit within concentric recesses made part of said plunger cylinder and said plunger retainer, respectively, said spring having sufficient resiliency to prevent axial movement of said plunger retainer about said cylindrical barrel as said spring cycles from a compressed state to an expanded state.

15. An improved collet assembly as set forth in claim 14, wherein said plunger retainer comprises at least a pair of concentric grooves for receiving a corresponding number of elastomeric o-rings, each having a thickness to permit one-half thereof to extend beyond an exterior surface of said plunger retainer to mate with and tighteningly engage an inner wall made part of said cylindrical barrel, said plunger retainer being positioned within said cylindrical barrel insofar to adjust and control the extent of resiliency of said spring.

16. An improved collet assembly as set forth in claim 14, wherein said tapered nose section comprises at least three longitudinal slots defining a corresponding number of collet segments and an aperture at an outermost end thereof for receiving a portion of the workpiece, said longitudinal slots comprising an axially extending protrusion extending longitudinally thereabout, substantially starting from an end of said tapered nose section to approximately the location of an upwardly flared section of said collet body, said axially extending protrusions extending inwardly a predetermined distance to effectively limit the extent to which said collet segments radially move inward to grip the workpiece while affording ample area for intrusion of lubricating oils into said cylindrical barrel.

17. An improved collet assembly as set forth in claim 14, wherein said collet body further comprises a plunger stop located within said cylindrical barrel, near said upwardly flared section, and adaptably configured to limit the extent of axial, forward travel of said plunger assembly within said cylindrical barrel as biasing means extends fully therewithin.

18. An improved collet assembly as set forth in claim 14, wherein said plunger cylinder further comprises an outermost concentric edge substantially chambered to correspond to the geometric configuration of a plunger stop located near said upwardly flared section of said cylindrical barrel, said plunger stop serving to limit the extent of axial, forward travel of said plunger assembly within said cylindrical barrel, most notably mating with said outermost concentric edge during full extension of biasing means.

19. An improved collet assembly as set forth in claim 14, wherein said collet body is fabricated from high grade carbon steel to ensure long-term wear, while said plunger assembly is fabricated from stainless steel to ensure sustained reliability during cyclic operation.

20. An improved collet assembly made adaptable for use in a computer numerical controlled machine having a sub-spindle being geometrically configured to accept and receive a correspondingly configured collet assembly, said collet assembly comprising, in combination:
a collet body having a tapered nose section for engaging a portion of a workpiece, a cylindrical barrel to house a plunger assembly and an upwardly flared section to serve as a stop within the sub-spindle, said plunger assembly comprising a plunger rod integrally attached to a plunger cylinder near a first end having internal threads thereat and second end thereof adaptably configured to extend beyond said cylindrical barrel a predetermined distance, said tapered nose section comprising at least three longitudinal slots defining a corresponding number of collet segments and an aperture at an outermost end thereof for receiving a portion of the workpiece, said longitudinal slots comprising an axially extending protrusion extending longitudinally thereabout, substantially starting from an end of said tapered nose section to approximately the location of an upwardly flared section of said collet body, said axially extending protrusions extending inwardly a predetermined distance to effectively limit the extent to which said collet segments radially move inward to grip the workpiece while affording ample area for intrusion of lubricating oils into said cylindrical barrel;
a plunger retainer having at least a pair of concentric grooves for receiving a corresponding number of elastomeric o-rings, each having a thickness to permit one-half thereof to extend beyond an exterior surface of said plunger retainer to mate with and tighteningly engage an inner wall made part of said cylindrical barrel, said plunger retainer being positioned within said cylindrical barrel insofar to adjust and control the extent of resiliency of said spring;
an ejector tip having a threaded end threadably engaged to said first end of said plunger rod and a non-threaded end extending through and beyond said tapered nose section a predetermined distance;
a spring having first and second ends, each being geometrically configured to fit within concentric recesses made part of said plunger cylinder and said plunger retainer, respectively, said spring having sufficient resiliency to prevent axial movement of said plunger retainer about said cylindrical barrel as said spring cycles from a compressed state to an expanded state;
a plunger stop positioned within said cylindrical barrel, near said upwardly flared section, and adaptably configured to limit the extent of axial, forward travel of said plunger assembly within said cylindrical barrel as said spring extends fully therewithin;

21. An improved collet assembly as set forth in claim 20, wherein said plunger retainer further comprises an extended section having an exterior portion integrally configured with a knurled pattern, said extended section substantially being an extension of said plunger retainer in terms of shape and form and further geometrically configured to fit within an inner cylindrical space formed by a square spring generally made part of the sub-spindle.

22. An improved method of holding and ejecting a workpiece from a sub-spindle, said method comprising the steps of:
providing a collet body having a tapered nose section for engaging a portion of a workpiece, a cylindrical barrel to house a plunger assembly and an upwardly flared section to serve as a stop within the sub-spindle, said plunger assembly comprising a plunger rod integrally attached to a plunger cylinder near a first end having internal threads thereat and second end thereof adaptably configured to slidably engage through an axially extending aperture made part of a plunger retainer, said tapered nose section comprising at least three longitudinal slots defining a corresponding number of collet segments and an aperture at an outermost end thereof for receiving a portion of the workpiece;
fitting an ejector tip to said plunger assembly by threadably engaging said first end of said plunger rod to a threaded end of said ejector tip, said ejector tip further comprising a non-threaded end extending through and beyond said tapered nose section a predetermined distance to permit engagement with the workpiece;
configuring a spring having first and second ends to said plunger rod, each end being geometrically configured to fit within concentric recesses made part of said plunger cylinder and said plunger retainer, respectively, said plunger retainer comprising at least a pair of concentric grooves for receiving a corresponding number of elastomeric o-rings, each having a thickness to permit one-half thereof to extend beyond an exterior surface of said plunger retainer to mate with and tighteningly engage an inner wall made part of said cylindrical barrel, said plunger retainer being positioned within said cylindrical barrel insofar to adjust and control the extent of resiliency of said spring, whereby said plunger cylinder retracts and moves axially through said cylindrical barrel compressing said spring as said ejector tip engages the workpiece and advances forward as said collet segments operably open to release and eject the workpiece from said collet body.
